(19) United States
(12) Patent Application Publication
(10) Pub. No.: US 2014/0086175 A1
(43) Pub. Date: Mar. 27, 2014

(54) METHODS, APPARATUS AND COMPUTER PROGRAMS FOR CONTROLLING RETRANSMISSIONS OF WIRELESS SIGNALS

(71) Applicant: RENESAS MOBILE CORPORATION, TOKYO (JP)

(72) Inventors: Sami-Jukka HAKOLA, Kempele (FI); Samuli TURTINEN, Ii (FI); Timo Kalevi KOSKELA, Oulu (FI); Matti Juhani PIKKARAINEN, Oulu (FI); Ville Pekka VARTIAINEN, Oulu (FI); Anna PANTELIDOU, Oulu (FI); Juha KARJALAINEN, Oulu (FI)

(73) Assignee: RENESAS MOBILE CORPORATION, TOKYO (JP)

(21) Appl. No.: 14/038,063

(22) Filed: Sep. 26, 2013

(30) Foreign Application Priority Data
Sep. 26, 2012 (GB) 1217186.4

(51) Int. Cl. H04W 72/12

(52) U.S. Cl. CPC H04W 72/1242
USPC 370/329

(57) ABSTRACT

A wireless device operates in a wireless cellular network under control of a network control apparatus. The wireless device transmits a signal to the network control apparatus. The wireless device receives from the network control apparatus a negative acknowledgement of receipt of the signal in accordance with an automatic repeat request process, The negative acknowledgement indicates that the signal was not received or was not received correctly by the network control apparatus. The wireless device either does not retransmit the signal to the network control apparatus or delays the retransmission of the signal to the network control apparatus in order to avoid conflict with a device-to-device discovery signal being sent by another wireless device.

### CROSS REFERENCE TO RELATED APPLICATION

This application claims the benefit under 35 U.S.C. 119(a) and 37 CFR §155 to UK Patent Application No. GB 1217186.4, filed on Sep. 26, 2012, the entire content of which is hereby incorporated by reference.

Reference is also made to U.S. patent application Ser. No. 13/860,086 filed Apr. 10, 2013, the entire content of which is hereby incorporated by reference.

### TECHNICAL FIELD

The present invention relates to methods, apparatus and computer programs for controlling retransmissions of wireless signals.

### BACKGROUND INFORMATION

The following abbreviations which may be found in the specification and/or the drawing figures are defined as follows:

ACK acknowledgement

ARQ automatic repeat request

CRC cyclic redundancy check

D2D device-to-device

eNB, eNodeB evolved Node B/base station in an E-UTRAN system

E-UTRAN Evolved UTRAN (LIE)

FDD frequency division duplex

FEC forward error correction

GSM Global System for Mobile Communications

HARQ hybrid automatic repeat request

LTE Long Term Evolution

LTE-A Long Term Evolution Advanced

M2M machine-to-machine

MTC machine-type communication

NACK negative acknowledgement

OFDM orthogonal frequency-division multiplexing

PDSCH physical downlink shared channel

PDCCH physical downlink control channel

PHICH physical HARQ indicator channel

PUCCH physical uplink control channel

PUSCH physical uplink shared channel

RRC radio resource control

RTT round trip time

TDD time division duplex

Tx transmission

UE user equipment

UMTS Universal Mobile Telecommunications System

UTRAN Universal Terrestrial Radio Access Network

WCDMA Wideband Code Division Multiple Access

D2D communications have been the subject of increasing research in recent years. D2D encompasses direct communication among portable devices without utilizing nodes/base stations of an infrastructure-based wireless network (typically a cellular network, such as GSM, WCDMA, LTE or the like). D2D communications reduce the load on base stations/wireless networks and also presents new service opportunities. There is a subset of D2D commonly termed M2M (or equivalently MTC) which refers to automated communications from and to radio devices that are not user-controlled, such as for example smart meters, traffic monitors and many other types. Typically, M2M communications are infrequent and carry only small amounts of data compared to cellular communications and D2D communications that are not M2M. To keep costs low, given their more focused purposes, many M2M devices have quite limited capabilities as compared to conventional UEs.

As an example in relation to LTE and LTE-A systems, there has been proposed a study item to evolve the LTE platform in order to cope with the demand of such D2D communications by studying enhancements to the LIE radio layers that allow devices to discover each other directly over the air and potentially communicate directly when viable, taking system management and network supervision into account. See for example documents Tdoc-RP-110706 entitled “On the need for a 3GPP study on LTE device-to-device discovery and communication”; Tdoc RP-110707 entitled “Study on LTE Device to Device Discovery and Communication—Radio Aspects”; and Tdoe-RP-110708 entitled “Study on LTE Device to Device Discovery and Communication—Service and System Aspects”; each by Qualcomm, Inc.; TSG RAN#52; Bratislava, Slovakia; May 31-Jun. 3, 2011. Document RP-110106 describes one of the main targets is that the “radio-based discovery process needs also to be coupled with a system architecture and a security architecture that allow the 3GPP operators to retain control of the device behavior, for example who can emit discovery signals, when and where, what information do they carry, and what devices should do once they discover each other.”

One 3GPP working group is currently discussing and defining use cases and service requirements for the D2D. Such use cases include social applications, local advertising, multiplayer gaming, network offloading, smart meters and public safety. Specifically, social applications can use D2D for the exchange of files, photos, text messages, etc., VoIP conversations, one-way streaming video and two-way video conferencing. Multiplayer gaming can use D2D for exchanging high resolution media (voice & video) interactively either with all participants or only with team members within a game environment. In this gaming use case, the control inputs are expected to be received by all game participants with an ability to maintain causality. Network offloading can utilize D2D when an opportunistic proximity offload potential exists. For example, a first device can initiate transfer of a media flow from the macro network to a proximity communications session with a second device, thereby conserving macro network resources while maintaining the quality of the user experience for the media session. Smart meters can use D2D communication among low capability MTC devices, for vehicular communication (for safety and non-safety purposes), and possibly also general M2M communication among different capability devices/machines. in the public safety regime, there can be either network-controlled D2D or a pure ad hoc D2D which does not utilize any network infrastructure for setting up or maintaining the D2D links. These are the two main categories of D2D networks, one taking place under control of a controlling (cellular) network and typically using licensed spectrum, and the other being ad hoc D2D which can work autonomously without network coverage.

In the cellular-controlled approach generally, including but not limited to LTE and LTE-A systems, the discovery communications, by which devices can discover each other's presence, are likely to be multiplexed with the (normal) cellular communications taking place on the same radio resources, However, it is important to ensure that (normal) cellular communications that conventionally take place can accommodate these discovery communications.

### SUMMARY

In a first exemplary embodiment of the invention, there is a method of operating a wireless device in a wireless cellular network under control of a network control apparatus, the method including: the wireless device transmitting a signal to the network control apparatus; and the wireless device receiving from the network control apparatus a negative acknowledgement of receipt of the signal in accordance with an automatic repeat request process, the negative acknowledgement indicating that the signal was not received or was not received correctly by the network control apparatus; the wireless device either not retransmitting the signal to the network control apparatus or delaying the retransmission of the signal to the network control apparatus in order to avoid conflict with a device-to-device discovery signal being sent by another wireless device.

In a second exemplary embodiment of the invention, there is apparatus for a wireless device, the apparatus including: at least one processor; and at least one memory including computer program code; the at least one memory and the computer program code being configured to, with the at least one processor, cause the wireless device to: transmit a signal to a. network control apparatus that controls a wireless cellular network that provides service for the wireless device; and following receipt by the wireless device from said network control apparatus of a negative acknowledgement of receipt of the signal in accordance with an automatic repeat request process, the negative acknowledgement indicating that the signal was not received or was not received correctly by said network control apparatus, the wireless device either not retransmitting the signal to said network control apparatus or delaying the retransmission of the signal to said network control apparatus in order to avoid conflict with a device-to-device discovery signal being sent by another wireless device.

There may also be provided a computer program including instructions such that when the computer program is executed on a wireless device operating in a wireless cellular network under control of a network control apparatus, the wireless device is arranged to: transmit a signal to a network control apparatus that controls a wireless cellular network that provides service for the wireless device; and following receipt by the wireless device from said network control apparatus of a negative acknowledgement of receipt of the signal in accordance with an automatic repeat request process, the negative acknowledgement indicating that the signal was not received or was not received correctly by said network control apparatus, the wireless device either riot retransmitting the signal to said network control apparatus or delaying, the retransmission of the signal to said network control apparatus hi order to avoid conflict with a device-to-device discovery signal being sent by another wireless device.

In a third exemplary embodiment of the invention, there is a method of operating a network control apparatus that controls a wireless device served by a wireless cellular network under control of the network control apparatus, the method including: the network control apparatus transmitting a negative acknowledgement of receipt of a signal sent by the wireless device in accordance with an automatic repeat request process, the negative acknowledgement indicating that the signal was not received or was not received correctly by the network control apparatus; and the network control apparatus assigning a new automatic repeat request process number for a retransmission of the signal by the wireless device to the network control apparatus, the new automatic repeat request process number being different from the automatic repeat request process number of the negative acknowledgement of receipt of the signal sent by the network control apparatus, thereby to avoid said retransmission conflicting with a device-to-device discovery signal being sent by another wireless device.

In a fourth exemplary embodiment of the invention, there is apparatus including a processing system for a network control apparatus that controls a wireless cellular network, the processing system being arranged to cause the network control apparatus to: transmit a negative acknowledgement of receipt of a signal sent by a wireless device in accordance with an automatic repeat request process, the negative acknowledgement indicating that the signal was not received or was not received correctly by the network control apparatus; and assign a new automatic repeat request process number for a retransmission of the signal by the wireless device to the network control apparatus, the new automatic repeat request process number being different from the automatic repeat request process number of the negative acknowledgement of receipt of the signal sent by the network control apparatus, thereby to avoid said retransmission conflicting with a device-to-device discovery signal being sent by another wireless device.

There may also be provided a computer program including instructions such that when the computer program is executed on a network control apparatus that controls a wireless cellular network, the network control apparatus is arranged to: transmit a negative acknowledgement of receipt of a signal sent by a wireless device in accordance with an automatic repeat request process, the negative acknowledgement indicating that the signal was not received or was not received correctly by the network control apparatus; and assign a new automatic repeat request process number for a retransmission of the signal by the wireless device to the network control apparatus, the new automatic repeat request process number being different from the automatic repeat request process number of the negative acknowledgement of receipt of the signal sent by the network control apparatus, thereby to avoid said retransmission conflicting with a device-to-device discovery signal being sent by another wireless device.

There may be provided a non-transitory computer-readable storage medium including a set of computer-readable. instructions stored thereon, which, when executed by a processing system, cause the processing system to carry out any of the methods as described above.

The processing systems described above may include at least one processor and at least one memory including computer program instructions, the at least one memory and the computer program instructions being configured to, with the at least one processor, cause the apparatus at least to perform as described above.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows schematically multiplexing of discovery signals with other cellular communications;

FIG. 2 shows schematically an uplink transmission frame;

FIG. 3 shows schematically an example of a wireless device, a base station and a network control apparatus;

FIG. 4 shows a schematic timing diagram for an example of uplink transmissions and downlink transmissions;

FIG. 5 shows a schematic timing diagram for an example of uplink transmissions and downlink transmissions according to an embodiment of the present invention;

FIG. 6 shows a schematic timing diagram for another example of uplink transmissions and downlink transmissions according to an embodiment of the present invention; and

FIGS. 7 and 8 show schematic timing diagrams for two variants of another example of uplink transmissions and downlink transmissions according to an embodiment of the present invention.

### DETAILED DESCRIPTION

Some exemplary embodiments help prevent or minimize interference or collisions between device-to-device- discovery signals and cellular signals being transmitted by the wireless device, particularly uplink retransmissions being transmitted by the wireless device and which make use of the same transmission resource.

In an example of the first and second exemplary embodiments, the wireless device delays the retransmission of the signal to the network control apparatus to occur later than the sending of the device-to-device discovery signal being sent by the other wireless device by one round trip time of the automatic repeat request process.

In an example of the first and second exemplary embodiments, the wireless device autonomously delays the retransmission of the signal to the network control apparatus. The wireless device may retransmit the signal to the network control apparatus in response to receiving from the network control apparatus a further negative acknowledgement of receipt of the signal. In an example embodiment, the wireless device is inhibited from delaying the retransmission of another signal to the network control apparatus within a predetermined period. of time from autonomously delaying the retransmission of the first signal.

In an example of the first and second exemplary embodiments, the wireless device delays the retransmission of the signal to the network control apparatus by a new automatic repeat request process number being assigned for the retransmission of the signal to the network control apparatus, the new automatic repeat request process number being different from the automatic repeat request process number of the negative acknowledgement of receipt of the signal originally received from the network control apparatus. In an example embodiment, the new automatic repeat request process number assigned for the retransmission of the signal to the network control apparatus is such that the retransmission of the signal to the network control apparatus takes place after the device-to-device discovery signal being sent by another wireless device. In an example embodiment, the new automatic repeat request process number is allocated from at least one of another serving cell and another component carrier of the wireless device.

In an example of the first and second exemplary embodiments, the wireless device includes an automatic repeat request buffer, the wireless device flushing the corresponding automatic repeat request process from the automatic repeat request buffer so as not to retransmit the signal to the network control apparatus.

In an example of the first and second exemplary embodiments, the wireless device assumes that the maximum number of transmissions of the corresponding automatic repeat request process has been reached so as not to retransmit the signal to the network control apparatus.

The wireless device may be a user equipment.

In an example of the third and fourth exemplary embodiments, the new automatic repeat request process number assigned for the retransmission of the signal to the network control apparatus is such that the retransmission of the signal to the network control apparatus takes place after the device-to-device discovery signal being sent by another wireless device.

In an example of the third and fourth exemplary embodiments, the new automatic repeat request process number is allocated from at least one of another serving cell and another component carrier of the wireless device.

In an example embodiment, the wireless cellular network is a Long Term Evolution or a Long Terra Evolution Advanced network.

In an example embodiment, the automatic repeat request process is a hybrid automatic repeat request process.

“Wireless devices” include in general any device capable of connecting wirelessly to a network, and includes in particular mobile devices including mobile or cell phones (including so-called “smart phones”), personal digital assistants, pagers, tablet and laptop computers, content-consumption or generation devices (for music and/or video for example), data cards, USE dangles, etc., as well as fixed or more static devices, such as personal computers, game consoles and other generally static entertainment devices, various other domestic and non-domestic machines and devices, etc. The term “user equipment” or UE is often used to refer to wireless devices in general, including mobile wireless devices in particular.

Reference will sometimes be made in this specification to “network”, “network control apparatus” and “base station”. In this respect, it will be understood that the “network control apparatus” is the overall apparatus that provides for general management and control of the network and connected devices. Such apparatus may in practice be constituted by several. discrete pieces of equipment. As a particular example in the context of UMTS (Universal Mobile Telecommunications System), the network control apparatus may be constituted by for example a so-called Radio Network Controller operating in conjunction with one or more Node Bs (Which, in many respects, can be regarded as “base stations”). As another example, LTE (Long Term Evolution) makes use of a so-called Evolved Node B (eNB) where the RF transceiver and resource management/control functions are combined into a single entity. The term “base station” is used in this specification to include a “traditional” base station, a Node B, an evolved Node B (eNB), or any other access point to a network, unless the context requires otherwise. Moreover for convenience and by convention, the terms “network control apparatus” and “base station” will often be used interchangeably. Much of the present description is given in respect of wireless devices operating according to LTE. It will be appreciated however that much of the following can he applied to wireless devices operating according to other wireless standards using different radio access technologies.

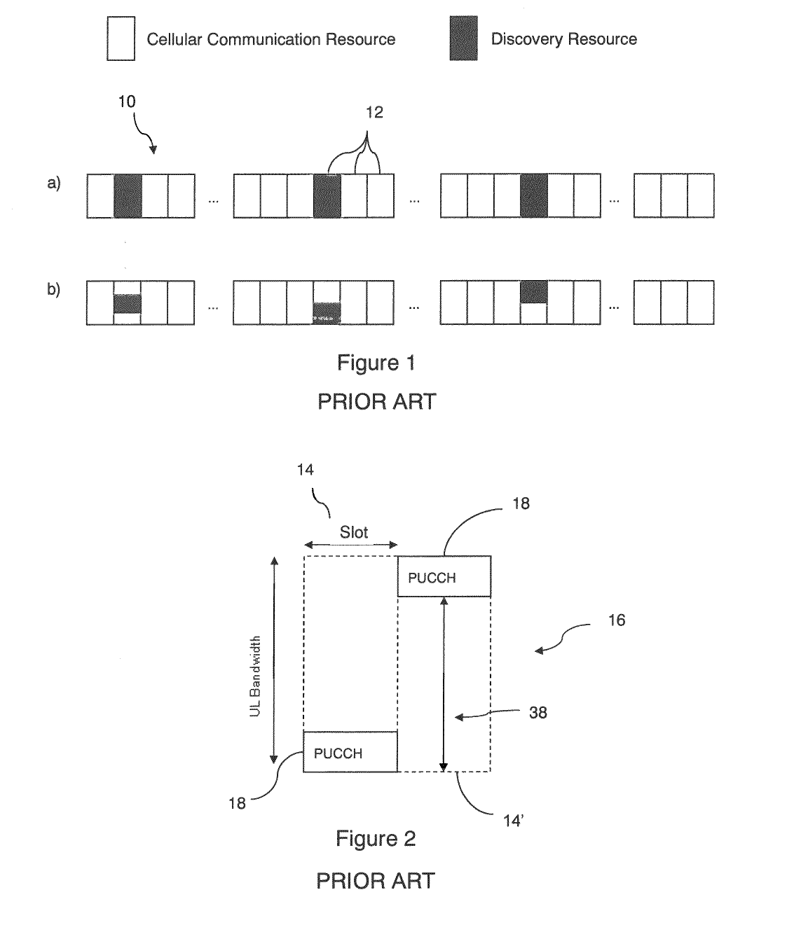

As mentioned briefly above, in the cellular-controlled approach for D2D communications, the discovery communications, by which devices can communicate directly with each other to discover each other's presence and set up D2D communications with each other, may he multiplexed with the (normal) cellular communications to and from the cell base station which are taking place on the same radio resources (i.e. in general, the same transmission frequencies and time slots). This discovery function can typically be considered to happen in the background with a low duty cycle so as to have a minimal impact on the energy consumption of the devices. The radio resources for the discovery may be multiplexed in the time domain or in both the time domain and frequency domain with the cellular communications. This is illustrated schematically in FIG. 1 which shows frames (or subframes) 10 which are notionally divided into slots 12 being successively transmitted/received. The upper part a) of FIG. 1 shows multiplexing of the discovery signals with other cellular communications in the time domain only, i.e. with the discovery signals (shown with shading) using a particular time slot in each frame with the remaining time slots being used by other cellular communications (shown with no shading). The lower part b) of FIG. 1 shows multiplexing of the discovery signals with other cellular communications in the time domain and frequency domain, with frequency being indicated vertically. As shown, discovery signals that are spaced in time also use different frequencies in this case. It is mentioned here that in the particular example of LTE (Long Term Evolution), the duration of a subframe is 1 ms, the subframe consisting of two slots of duration 0.5 ms each.

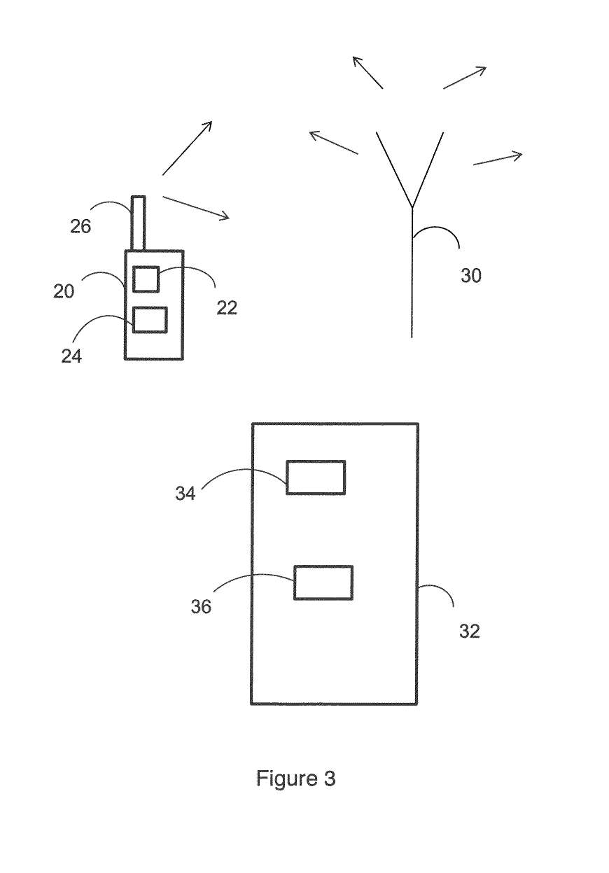

Here it is noted that in LTE Release 8 onwards, the first few symbols of each downlink subframe over the whole operating bandwidth are reserved for control channels, referred to as the PDCCH (physical downlink control channel). Control signals sent over these downlink control channels include for example a format indicator to indicate the number of OFDM (orthogonal frequency-division multiplexing) symbols used for control in this subframe, scheduling control information (downlink assignment and uplink scheduling grant), and downlink ACKs/NACKs (acknowledgement and negative acknowledgements) associated with uplink data transmission, which is used for HARQ (hybrid automatic repeat request) for error correction. On the other hand, uplink control signals are located at the outer edges of the operating bandwidth, These uplink control signals include for example ACKs/NACKs associated with downlink data transmission, channel quality indicators and scheduling request indicators. This frequency location of the uplink control signals is shown schematically in FIG. 2. In the first slot 14 of a subframe 16, the lower end of the available uplink spectrum is used for the uplink control channel 16, and the higher end of the available uplink spectrum is used for the uplink control channel 18 in the second slot 14′ of the subframe 16. This so-called frequency diversity assists in minimizing the effect of interference to these control channels caused by other transmissions in the radio environment as well as the interference effect of transmission of these control channels on other nearby devices. In the case of LTE, these uplink control signals are sent over an uplink control channel 18 known as PUCCH (physical uplink control channel) which is transmitted on a reserved frequency region in the uplink. Similar physical uplink control channels are known and used in other radio access technologies.

These uplink control signals in a cellular system, including for example an LTE system, are important and therefore it is typically important to ensure that the effect of any D2D activity on these is minimized or avoided altogether. This is particularly the case for HARQ ACK/NACK signals and HARQ retransmissions as these are critical for effective error control in a cellular system, including in LTE for example. However, particular problems arise for the uplink given that the cellular uplink control signals are transmitted using all symbols/slots in the time domain (i.e. they effectively fill the time periods allowed for transmission).

With regard to hybrid automatic repeat request (hybrid ARQ or HARQ), as is known per se HARQ is a combination of forward error-correcting coding and ARQ error-control. In standard ARQ, redundant bits are added to data to be transmitted using an error-detecting code, such as a cyclic redundancy check (CRC). If a receiver detects a corrupted message, it will request the sender to retransmit the message. In Hybrid ARQ, the original data is encoded with a forward error correction (FEC) code. The FEC code is chosen to correct an expected subset of all errors that may occur, while the ARQ method is used as a fall-back to correct errors that are uncorrectable using only the redundancy sent in the initial transmission. In LTE in particular, there is the Physical Hybrid ARQ Indicator Channel (PHICH) which is used to report the Hybrid ARQ status. PHICH carries the HARQ ACK/NACK signal sent by the transmitter to the receiver to indicate whether a message (in particular a transport block) has been correctly received. The HARQ indicator is 1 bit long: ‘0’ indicates ACK (i.e. an indication that the message has been correctly received), and ‘1’ indicates NACK (i.e. an indication that the message has not been correctly received). The PHICH is transmitted within the control region of the subframe and is typically only transmitted within the first symbol, If the receiver receives a NACK, it will retransmit the message, This process of receiving a NACK and retransmitting the message is typically repeated up to a predetermined number of times, which may vary according to radio conditions for example. HARQ messages are typically spaced by about a round trip time (RTT) delay, which is the time interval between the initial transmission and the retransmission. In for example LTE FDD (frequency division duplex), the RTT is 8 ms. On the other hand, in for example LTE TDD (time division duplex), the RTT depends on the active downlink/uplink configuration and may be for example between 10 ms to 16 ms. Moreover, in general, plural HARQ processes, relating to plural different transmissions, may be taking place effectively in parallel, each with its own identifying HARQ process number. In LTE, in the downlink, the HARQ processes are asynchronous and thus can be used in any order, with the HARQ process number for each HARQ process being indicated in downlink transmissions. In LTE, in the uplink, the HARQ processes are synchronous so that the wireless devices have to use a specific process in a specific subframe, with the same HARQ process number being used every 8 subframes, though the corresponding HARQ process number does not have to be explicitly indicated as the base station “knows” when to expect a particular HARQ retransmission.

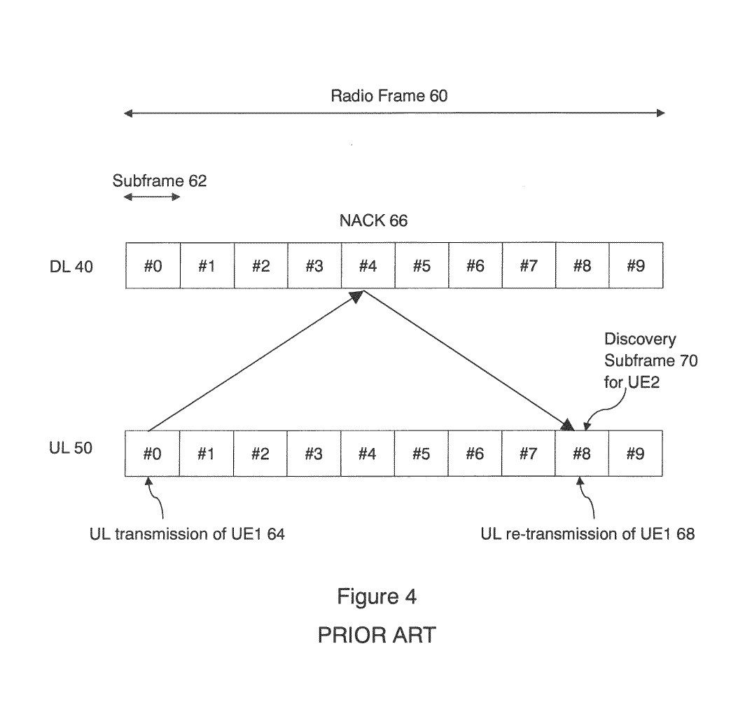

FIG. 3 shows schematically an example of a wireless device 20. The wireless device 20 contains the necessary radio module 22, processor(s) and memory/memories 24, antenna 26, etc. to enable wireless communication with the network. The wireless device 20 in use is in communication with a radio mast 30. As a particular example in the context of UMTS (Universal Mobile Telecommunications System), there may be a network control apparatus 32 (which may be constituted by for example a so-called Radio Network Controller) operating in conjunction with one or more Node Bs (which, in many respects, can be regarded as “base stations”). As another example, LTE (Long Term Evolution) makes use of a so-called Evolved Node B (eNB) where the RF transceiver and resource management/control functions are combined into a single entity. The term “base station” is used in this specification to include a “traditional” base station, a Node B, an evolved Node B (eNB), or any other access point to a network, unless the context requires otherwise. The network control apparatus 32 (of whatever type) may have its own processor(s) 34 and memory/memories 36, etc.

As mentioned, a particular problem that can arise on the uplink from the wireless device 20 to the base station/network 30,32 in the context of D2D is that signals relating to the D2D activity may clash with signals relating to cellular activity. A particular example where problems may result is the case of HARQ ACK/NACK signals and HARQ retransmissions in particular as these are critical for effective error control in a cellular system, including in LTE for example.

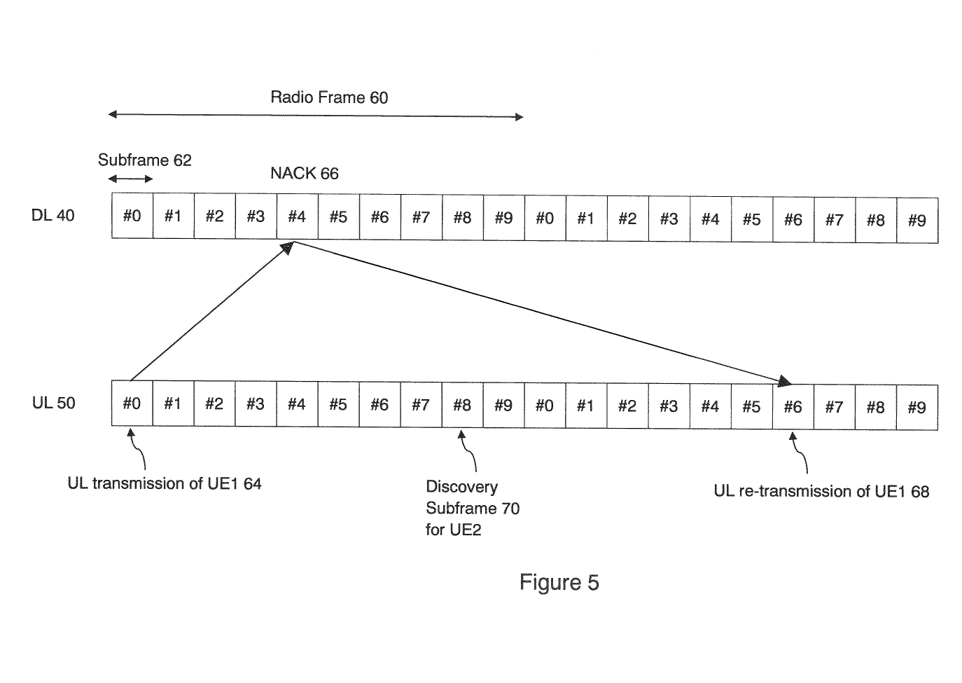

Referring for example to FIG. 4, there is shown schematically a timing diagram for a downlink 40 to and an uplink 50 from a wireless device UE1 20. In this example, a radio frame 60 extends over ten subframes #0-#9 62. In general, in a cellular wireless system, there may be fixed occasions in both downlink 40 and uplink 50 wherein feedback for a transmission may be awaited. For example, in LTE FDD the delay is always four subframes 62 (which is typically 4 ms as normally a subframe is of 1 ms duration in LTE). Thus, if an uplink transmission 64 is sent by the wireless device UE1 20 in subframe n (subframe #0 in the example of FIG. 4), the downlink feedback 66 should be received at the wireless device UE1 20 in subframe n+4 (subframe #4 in the example of FIG. 4). Moreover, if the feedback 66 is negative (NACK), the wireless device UE1 20 will send an uplink retransmission 68 according to this same timing, i.e. in subframe n+4+4 (subframe #8 in the example of FIG. 4) of the uplink 50. The uplink transmissions 64 here may in general be of any type, including for example cellular user voice or data messages, and cellular control signals (including for example cellular uplink PUSCH transmissions).

Thus, as can be seen in FIG. 4, as a particular example that can cause problems, it can happen that an expected uplink retransmission 68 by the wireless device UE1 20, following receipt at the wireless device UE1 20 of a NACK from the network 30,32, may be scheduled to take place at the same time that another wireless device UE2 is scheduled to transmit a D2D discovery signal. Thus, both the uplink retransmission 68 by the first wireless device UE1 20 and the D2D discovery subframe 70 for the other wireless device UE2 are scheduled to occur during subframe #8 in the uplink 50 of the first wireless device UE1 20 in the example of FIG. 4. Whilst FIG. 4 and the specific examples discussed below principally illustrate the timing for uplink and downlink transmissions in a FDD system, where in this example there are in essence four subframes (of a total duration of 4 ms in LTE for example) between corresponding uplink transmissions and downlink transmissions and the HARQ RTT is eight subframes, a similar analysis applies in TDD systems, including LTE TDD systems. In a TDD system, the actual HARQ timing depends on the current active DL/UL configuration and therefore there is sometimes an additional delay due to unavailability of an UL subframe after a minimum processing time. Nevertheless, the same potential problem arises of an expected uplink retransmission by a first wireless device UE1 20, following receipt of a NACK from the network 30,32 at the first wireless device UE1 20, being scheduled to take place at the same time that another wireless device UE2 is scheduled to transmit a D2D discovery frame. This coinciding of HARQ uplink retransmissions and D2D discovery signal transmissions by different wireless devices typically occurs at the round trip time (RTT) of the HARQ signals, which, as noted, is eight subframes for LTE FDD and is variable and depends on the current active DL/UL configuration in LTE TDD.

In accordance with an example of one embodiment of the present invention, a wireless device 20 that is operating in a cellular network under the control of some network control apparatus 32 is caused to handle its HARQ transmissions (in particular its HARQ retransmissions) such as to prevent or at least minimize the risk of its HARQ transmissions (in particular its HARQ retransmissions) clashing or interfering with D2D discovery signal transmissions by one or more other wireless devices, in particular other wireless devices operating in the cellular network under the control of the network control apparatus 32. In operation in an example, the network control apparatus 32 (such as an eNB in the specific example of LTE communications) schedules or controls the D2D discovery subframes that are used or available to be used by the wireless devices serviced by the network control apparatus 32. The information may be broadcast by the network control apparatus 32 to the wireless devices in system information for example. Nevertheless, other arrangements are possible for the wireless device 20 to be aware of the timing of D2D discovery transmissions by other wireless devices. Moreover, whilst in the specific examples below, reference is typically made to D2D discovery transmissions being made by one other wireless device (referred to as UE2 below) in a particular subframe, it will be understood that plural other wireless devices may be transmitting D2D discovery signals in any particular subframe. In addition, whilst reference is typically made to adjusting or inhibiting HARQ retransmissions by a first wireless device 20 (referred to as UE1 below), it will be understood that plural other wireless devices under control of the network control apparatus 32 may operate in this way, and indeed all of the wireless devices under control of the network control apparatus 32 may operate in this way.

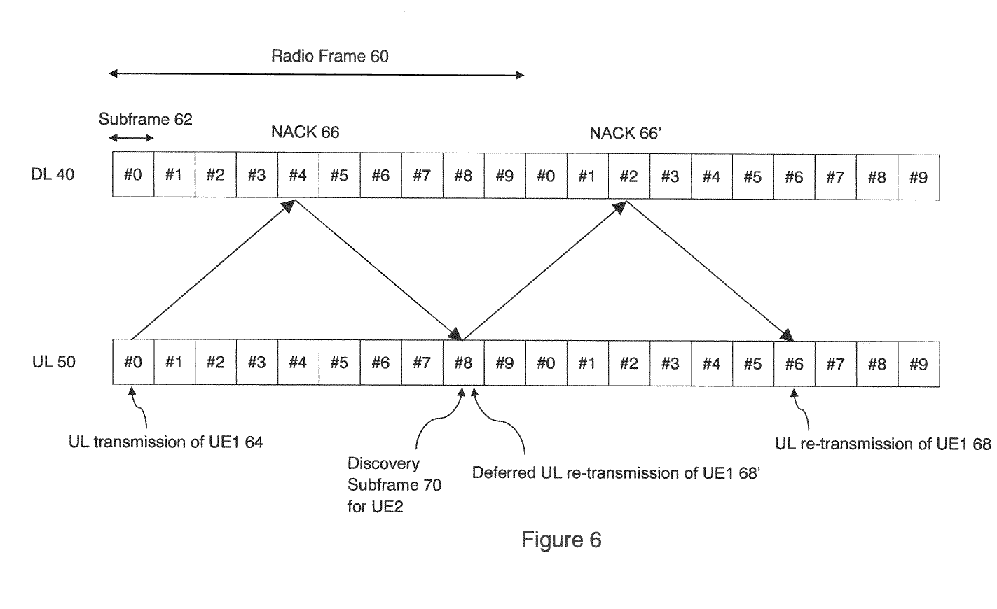

As a first example, referring to FIG. 5, the wireless device UE1 20 is configured so that if it receives a NACK from the base station/network 30,32 generally in a downlink subframe that corresponds to a D2D discovery subframe 70 scheduled for another wireless device UE2, the uplink retransmission by the first wireless device UE1 20 relating to that NACK is delayed so that it occurs in a different subframe from that used by other wireless device UE2 for sending the D2D discovery signal. In a specific example, the uplink retransmission by the first wireless device UE1 20 is delayed for one HARQ RTT. As a particular example in LTE FDD, the wireless device UE1 20 transmits its retransmission in UL subframe n+(4+8) where n is the downlink subframe where the NACK was received and 8 is the HARQ RTT in subframes.

This is shown schematically in FIG. 5 where there is a downlink 40 and an uplink 50 for the first wireless device UE1 20. The wireless device UE1 20 transmits in subframe #0 of the uplink 50, that uplink transmission in general being of any type, including for example cellular user voice or data messages, and cellular control signals (including for example cellular uplink PUSCH transmissions), That transmission is not correctly received by the network 30,32 for some reason, so four subframes later, at subframe #4 of the downlink 40, a NACK 66 is sent by the network 30,32 to the wireless device UE1 20 and received at the wireless device UE1 20. However, a D2D discovery signal is due to be sent by another wireless device UE2 a further four subframes later, which coincides with uplink subframe #8 70 of the first wireless device UE1 20. Accordingly, the first wireless device UE1 20 does not send its uplink retransmission in response to receiving the NACK 66 at the Usual four subframes later from the downlink subframe in which the NACK 66 was received, and instead delays that retransmission to avoid the retransmission clashing with the D2D discovery signal 70 of the other wireless device UE2. In the example shown in FIG. 5, the uplink retransmission 68 by the first wireless device UE1 20 takes place one HARQ RTT later than this, namely at n+4+8 in this case, where n is the downlink subframe in which the NACK transmission 66 took place. Thus, in the example shown in FIG. 5, the NACK transmission 66 by the network 30,32 for the first wireless device UE1 20 took place at downlink subframe #4, but the D2D discovery signal 70 of the other wireless device UE2 is scheduled for transmission four subframes later at subframe #8, so the corresponding uplink retransmission 68 by the first wireless device UE1 20 takes place in uplink subframe #6 of the next frame, i.e. one HARQ RTT or eight further subframes later.

The specific example for the timing given above is particularly relevant for an LTE FDD system. In LTE TDD, the actual HARQ timing depends on active downlink/uplink configuration and therefore there is sometimes an additional delay due to unavailability of an uplink subframe after minimum processing time. Nevertheless, the same principles apply with, in one example, the uplink retransmission by the first wireless device UE1 20 taking place one HARQ RTT later than is normal, in this case one HARQ RTT later than the uplink D2D discovery signal 70 by the other wireless device UE2. It is convenient to delay the uplink retransmission by the first wireless device UE1 20 in either case by one HARQ RTT as typically there will be a resource (i.e. a transmission slot) that is reserved for transmissions at that time. In general, however, some other delay, which may be shorter or longer, may be used. It may be noted moreover that in this example, the network 30/32 (in particular the network control apparatus 32, including as a particular example an eNB in the case of LTE) is preferably aware that the wireless device UE1 20 is attempting a HARQ retransmission one HARQ RTT later than usual. This may be achieved as part of the technical specification for this mode of operation.

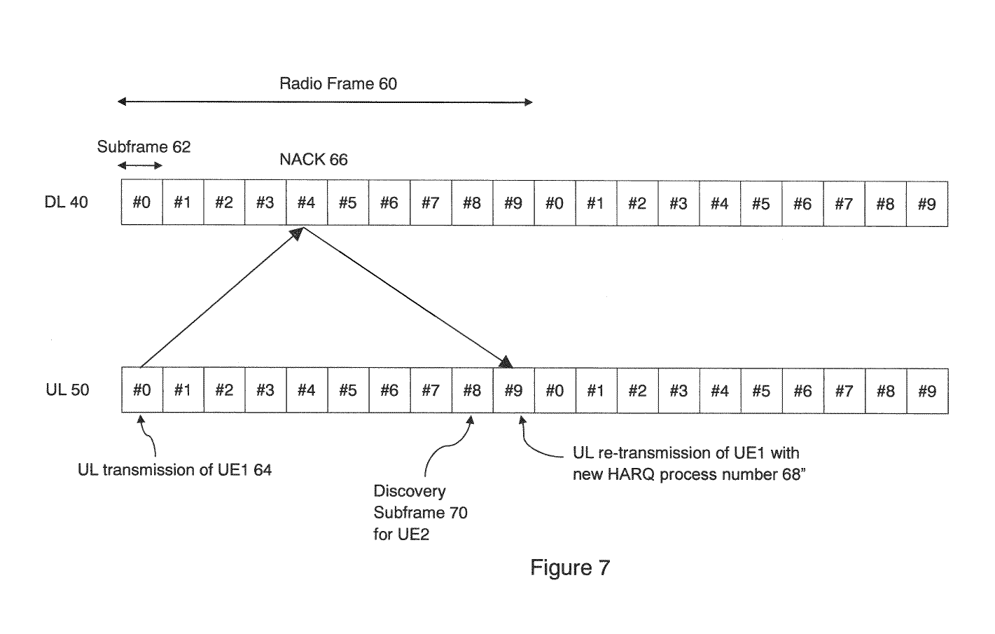

As another example, referring to FIG. 6, the wireless device UE1 20 is configured so that if it receives a NACK from the base station/network 30,32 in a downlink subframe that corresponds to a D2D discovery subframe 70 scheduled for another wireless device UE2, the first wireless device UE1 20 will autonomously defer its HARQ retransmission, that is without reference to and without the knowledge of the base station/network 30,32. In the example of FIG. 6, the first wireless device UE1 20 would normally make its HARQ retransmission 68′ at (first) uplink subframe #8, but this coincides with the D2D discovery subframe 70 scheduled for another wireless device UE2. Thus, the first wireless device UE1 20 decides not to make its HARQ retransmission at that time and defers or inhibits that HARQ retransmission. Because the base station/network 30,32 is in this example not aware that the expected HARQ retransmission 68′ has been inhibited by the first wireless device UE1 20 and has not received the expected retransmission from the first wireless device UE1 20, the base station/network 30,32 transmits another NACK 66′ eight subframes after the initial or previous MACK 66. Receipt of this further NACK 66′ by the first wireless device UE1 20 results in the first wireless device UE1 20 making its retransmission 68 one HARQ RTT (or eight subframes in this specific example for an LTE FDD system) after what would normally have been its initial retransmission. As an alternative to responding to receipt of a repeat NACK 66′ from the network, the first wireless device UE1 20 may autonomously and in any event make its retransmission 68 one HARQ RTT or eight subframes after what would normally have been its initial retransmission. Moreover, in one variant of this example, a prohibit timer is used for restricting the interval between two consecutive autonomous deferrals by the first wireless device UE1 20 so that two such deferrals do not happen quickly in succession. In one method, the prohibit timer is configurable by the network 30,32, e.g. via RRC (radio resource control) signaling with the wireless device UE1 20.

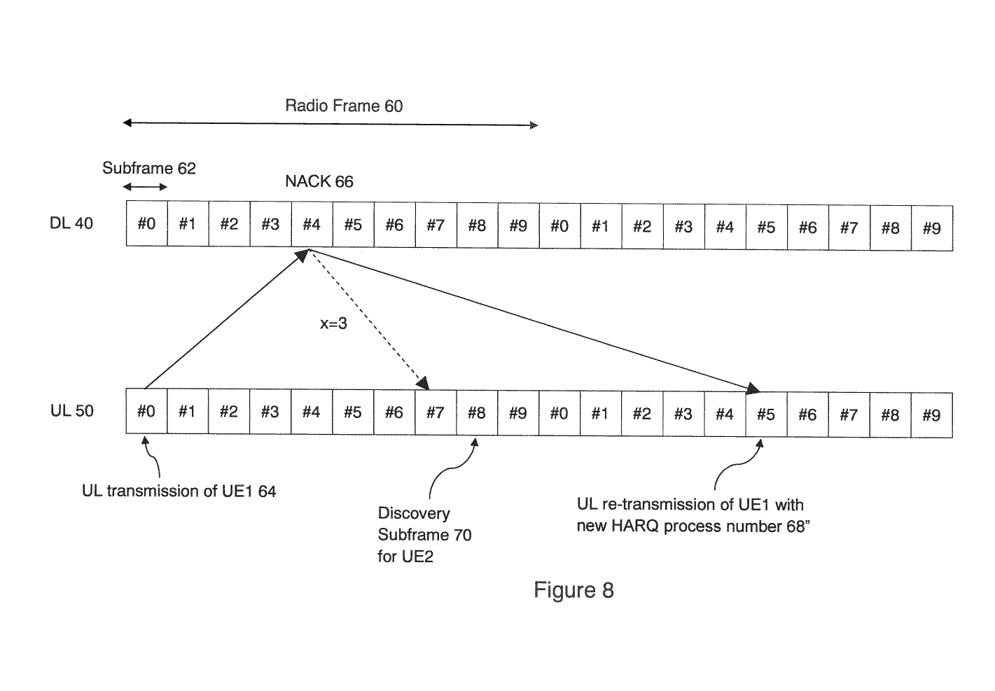

In the examples shown schematically in FIGS. 7 and 8, the network 30,32 assigns a new HARQ process number for the relevant HARQ process. In particular, if the network 30,32 transmits a NACK 66 for an uplink transmission 64 from a first wireless device UE1 20 in a downlink subframe the NACK 66 being transmitted in the first subframe #4 shown for the downlink 40 in the examples shown in FIGS. 7 and 8) that corresponds to a D2D discovery subframe 70 for another wireless device UE2 (the first subframe #8 shown for the uplink 50 in the examples shown in FIGS. 7 and 8), then the network 30,32 assigns a new HARQ process number for the HARQ process to which that particular NACK 66 relates. (This assigning of a new HARQ process number assumes that the amount of already configured HARQ processes is less than the maximum which the wireless device 20 and/or the network 30,32 supports, which in a specific example is eight HARQ processes.) In this way, the network 30,32 in effect controls the retransmissions by the wireless device UE1 20 to take place in a subframe that does not clash with a subframe being used by another wireless device UE2 for D2D discovery signals, in an example, the new HARQ process number is n+x where n is the downlink subframe number for the NACK sent by the network. In the specific example shown in FIG. 7, x=5 so that, given that the NACK 66 was sent in the downlink subframe #4, the uplink retransmission 68″ by the first wireless device UE1 20 takes place in uplink subframe #9. In a specific example, if the new HARQ process number occurs at uplink subframe n+x<n+4, then retransmission is delayed to be transmitted in subframe n+x+8, i.e. one HARQ RTT or 8 subframes later. This is shown schematically in FIG. 8 for the example where x=3: the subframe for the wireless device UE1 to send the retransmission 68″ is pushed out to #4+3+8=subframe #5 of the next radio frame.

In a variant of this last example, the new HARQ process is allocated from another serving cell/component carrier configured for the wireless device UE1 20, that is the HARQ process (in particular the sending of the retransmissions) takes place using another serving cell/component carrier, In one example of this, the HARQ process number in the other serving cell/component carrier is the same as used in the first serving cell/component carrier (where the UL retransmission by the wireless device UE1 20 would have collided with the D2D discovery subframe of another wireless device UE2). In other words, the HARQ process (in particular the sending of the retransmissions) used by the wireless device UE1 20 takes place effectively using the corresponding subframes (corresponding in time, with the same subframe number), but using a different serving cell/component carrier.

In another example (not shown), the first wireless device UE1 20 receiving a NACK from the network 30,32 in a downlink subframe that corresponds to a D2D discovery subframe by another wireless device UE2 flushes its HARQ buffer of the corresponding HARQ process (typically under control of the MAC (Medium Access Control) of the first wireless device UE1 20). In this way, the uplink packet that was originally transmitted by the first wireless device UE1 20 and not correctly received (and thus led to the NACK being sent by the network 30,32) is not retransmitted as part of the HARQ process and there will therefore be no interference with the D2D discovery subframe transmitted by the other wireless device UE2. The relevant uplink packet of the first wireless device UE1 20 may be retransmitted via higher layers in the first wireless device UE1 20, but this is a different process that will not affect the D2D transmissions discussed here.)

Alternatively or additionally, the wireless device UE1 20 is configured so that if it receives a NACK from the base station/network 30,32 in a downlink migraine that corresponds to a subframe scheduled for transmission of a D2D discovery by another wireless device UE2, the first wireless device UE1 20 inhibits the retransmission of any data or transport blocks or the like, and thus prevents a clash with the D2D discovery transmissions of the other wireless device UE2. One way to achieve this is for the first wireless device UE1 20 to assume that the maximum number of transmissions of this HARQ process has been reached in such a case. In one example of particular relevance to LTE, the maximum number of transmissions may be configured by at least one of the maxHARQ-Tx parameter and the maxHARQ-Msg3Tx parameter. This may result in loss of data for the cellular transmissions by the first wireless device UE1 20 that are taking place as there may be no retransmission of data or transport blocks or the like that were incorrectly received at the base station/network 30,32, but this may be acceptable (as it may only cause a short cut out in a voice call for example, which may be barely noticeable to the user).

Although at least some aspects of the embodiments described herein with reference to the drawings include computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may include a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

It will be. understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), etc. The chip or chips may include circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

The above embodiments are to be understood as illustrative examples of the invention. Much of the description above is given in respect of LTE systems, but the present invention is not limited to LIE systems and may be employed in other wireless networks employing or meeting different Standards or releases of Standards. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method of operating a wireless device in a wireless cellular network under control of a network control apparatus, the method comprising:
the wireless device transmitting a signal to the network control apparatus; and
the wireless device receiving from the network control apparatus a negative acknowledgement of receipt of the signal in accordance with an automatic repeat request process, the negative acknowledgement indicating that the signal was not received or was not received correctly by the network control apparatus;
the wireless device either not retransmitting the signal to the network control apparatus or delaying the retransmission of the signal to the network control apparatus in order to avoid conflict with a device-to-device discovery signal being sent by another wireless device.

2. The method according to claim 1, wherein the wireless device delays the retransmission of the signal to the network control apparatus to occur later than the sending of the device-to-device discovery signal being sent by the other wireless device by one round trip time of the automatic repeat request process.

3. The method according to claim 1, wherein the wireless device autonomously delays the retransmission of the signal to the network control apparatus.

4. The method according to claim 3, wherein the wireless device retransmits the signal to the network control apparatus in response to receiving from the network control apparatus a further negative acknowledgement of receipt of the signal.

5. The method according to claim 3, wherein the wireless device is inhibited from delaying the retransmission of another signal to the network control apparatus within a predetermined period of time from autonomously delaying the retransmission of the first signal.

6. The method according to claim 1, wherein the wireless device delays the retransmission of the signal to the network control apparatus by a new automatic repeat request process number being assigned for the retransmission of the signal to the network control apparatus, the new automatic repeat request process number being different from the automatic repeat request process number of the negative acknowledgement of receipt of the signal originally received from the network control apparatus.

7. The method according to claim 6, wherein the new automatic repeat request process number assigned for the retransmission of the signal to the network control. apparatus is such that the retransmission of the signal to the network control apparatus takes place after the device-to-device discovery signal being sent by another wireless device.

8. The method according to claim 6, wherein the new automatic repeat request process number is allocated from at least one of another serving cell and another component carrier of the wireless device.

9. The method according to claim 1, wherein the wireless device comprises an automatic repeat request buffer, the wireless device flushing the corresponding automatic repeat request process from the automatic repeat request buffer so as not to retransmit the signal to the network control apparatus.

10. The method according to claim 1, wherein the wireless device assumes that the maximum number of transmissions of the corresponding automatic repeat request process has been reached so as not to retransmit the signal to the network control apparatus.

11. An apparatus for a wireless device, the apparatus comprising:
at least one processor;
and at least one memory including computer program code;
the at least one memory and the computer program code being configured to, with the at least one processor, cause the wireless device to:
transmit a signal to a network control apparatus that controls a wireless cellular network that provides service for the wireless device; and
following receipt by the wireless device from said network control apparatus of a negative acknowledgement of receipt of the signal in accordance with an automatic repeat request process, the negative acknowledgement indicating that the signal was not received or was not received correctly by said network control apparatus, the wireless device either not retransmitting the signal to said network control apparatus or delaying the retransmission of the signal to said network control apparatus in order to avoid conflict with a device-to-device discovery signal being sent by another wireless device.

12. The apparatus according to claim 11, wherein the apparatus is arranged to delay the retransmission of the signal to said network control apparatus to occur later than the sending of the device-to-device discovery, signal being sent by the other wireless device by one round trip time of the automatic repeat request process.

13. The apparatus according to claim 11, wherein the apparatus is arranged such that the wireless device autonomously delays the retransmission of the signal to said network control apparatus.

14. The apparatus according to claim 13, wherein the apparatus is arranged such that the wireless device retransmits the signal to said network control apparatus in response to receiving from said network control apparatus a further negative, acknowledgement of receipt of the signal.

15. The apparatus according to claim 13, wherein the apparatus is arranged such that the wireless device is inhibited from delaying the retransmission of another signal to said network control apparatus within a predetermined period of time from autonomously delaying the retransmission of the first signal.

16. The apparatus according to claim 11, wherein the apparatus is arranged such that the wireless device delays the retransmission of the signal to said network control apparatus by a new automatic repeat request process number being assigned for the retransmission of the signal to said network control apparatus, the new automatic repeat request process number being different from the automatic repeat request process number of the negative acknowledgement of receipt of the signal originally received from said network Control apparatus.

17. The apparatus according to claim 16, wherein the new automatic repeat request process number assigned for the retransmission of the signal to said network control apparatus is such that the retransmission of the signal to said network control apparatus takes place after the device-to-device discovery signal being sent by another wireless device.

18. The apparatus according to claim 16, wherein the new automatic repeat request process number is allocated from at least one of another serving cell and another component carrier of the wireless device.

19. The apparatus according to claim 11, wherein the apparatus is arranged to flush the corresponding automatic repeat request process from an automatic repeat request buffer of the wireless device so as not to retransmit the signal to said network control apparatus.

20. The apparatus according to claim 11, wherein the apparatus is arranged such that the wireless device assumes that the maximum number of transmissions of the corresponding automatic repeat request process has been readied so as not to retransmit the signal to said network control apparatus.

21. A method of operating a network control apparatus that controls a wireless device served by a wireless cellular network under control of the network control apparatus, the method comprising:
the network control apparatus transmitting a negative acknowledgement of receipt of a signal sent by the wireless device in accordance with an automatic repeat request process, the negative acknowledgement indicating that the signal was not received or was not received correctly by the network control apparatus; and
the network control apparatus assigning a new automatic repeat request process number for a retransmission of the signal by the wireless device to the network control apparatus, the new automatic repeat request process number being different from the automatic repeat request process number of the negative acknowledgement of receipt of the signal sent by the network control apparatus, thereby to avoid said retransmission conflicting with a device-to-device discovery signal being sent by another wireless device.

22. An apparatus for a network control apparatus that controls a wireless cellular network, the apparatus comprising:
at least one processor;
and at least one memory including computer program code;
the at least one memory and the computer program code being configured to, with the at least one processor, cause the network control apparatus to:
transmit a negative acknowledgement of receipt of a signal sent by a wireless device in accordance with an automatic repeat request process, the negative acknowledgement indicating that the signal was not received or was not received correctly by the network control apparatus; and
assign a new automatic repeat request process number for a retransmission of the signal by the wireless device to the network control apparatus, the new automatic repeat request process number being different from the automatic repeat request process number of the negative acknowledgement of receipt of the signal sent by the network control apparatus, thereby to avoid said retransmission conflicting with a device-to-device discovery signal being sent by another wireless device.
